(19) United States
(12) Patent Application Publication
(10) Pub. No.: US 2024/0332856 A1
(43) Pub. Date: Oct. 3, 2024

(54) CONNECTOR

(71) Applicant: SUMITOMO WIRING SYSTEMS, LTD., Mie (JP)

(72) Inventor: Ryuta TAKAHASHI, Mie (JP)

(21) Appl. No.: 18/616,974

(22) Filed: Mar. 26, 2024

(30) Foreign Application Priority Data
Mar. 27, 2023 (JP) 2023-049915

(51) Int. Cl. H01R 13/52; H01R 4/18

(52) U.S. Cl. CPC H01R 13/5205; H01R 4/185

(57) ABSTRACT

A connector includes: a housing having a cavity extending in a front-rear direction; a terminal fitting that is housed in the cavity and connects to a front end portion of an electric wire; and a rubber plug that fits onto the electric wire and is coupled to the terminal fitting. The rubber plug includes: a body portion that has a seal lip that comes into close contact with an inner circumferential surface of the cavity; an extended portion that extends rearward from the body portion and is disposed outside the housing; and a bulging portion that bulges outward in a radial direction of the extended portion, and comes into contact with a rear surface of the housing in a state where the electric wire disposed inside the extended portion is bent in a direction that intersects the front-rear direction.

### CROSS-REFERENCE TO RELATED APPLICATIONS

This application is based on and claims priority from Japanese Patent Application No. 2023-049915, filed on Mar. 27, 2023, with the Japan Patent Office, the disclosure of which is incorporated herein in its entirety by reference.

### TECHNICAL FIELD

The present disclosure relates to a connector.

### BACKGROUND

JP H07-201406 A discloses a rubber plug that is inserted into a housing with an electric wire inserted therein. A front end portion of the rubber plug is crimped to a terminal fitting together with the electric wire. The portion of the electric wire drawn out rearward from the rubber plug is disposed outside the housing. Known rubber plugs with similar forms are disclosed in JP H10-247546 A, JP 2009-048928 A, and JP S58-037676 U.

### SUMMARY

Electric wires are prone to move about due to vibration that occurs when a vehicle is travelling. This movement causes the rubber plug to be swung around, which in turn causes the terminal fitting coupled to the electric wire to move about, and the connection portion with a partner terminal fitting may be subjected to wear.

A rubber plug-equipped terminal of the present disclosure was achieved based on the aforementioned circumstances, and aims to improve terminal connection reliability by ensuring that bending of an electric wire does not affect the terminal.

A connector of the present disclosure including: a housing having a cavity extending in a front-rear direction; a terminal fitting that is housed in the cavity and connects to a front end portion of an electric wire; and a rubber plug that fits onto the electric wire and is coupled to the terminal fitting, wherein the rubber plug includes: a body portion that has a seal lip that comes into close contact with an inner circumferential surface of the cavity; an extended portion that extends rearward from the body portion and is disposed outside the housing; and a bulging portion that bulges outward in a radial direction of the extended portion, and comes into contact with a rear surface of the housing in a state where the electric wire disposed inside the extended portion is bent in a direction that intersects the front-rear direction.

With the present disclosure, it is possible to improve the terminal connection reliability by ensuring that bending of the electric wire does not affect the terminal.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a side cross-sectional view of a rubber plug fixed to a terminal fitting housed in a cavity.

FIG. 2 is a perspective view of the rubber plug in Embodiment 1.

FIG. 3 is a side cross-sectional view of the rubber plug in Embodiment 1.

FIG. 4 is a side cross-sectional view of the rubber plug fixed to the terminal fitting housed in the cavity, in which a drawn-out portion of an electric wire extends bent in a direction that intersects a front-rear direction.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of Present Disclosure

First, embodiments of the present disclosure will be listed and described.

(1) A connector including: a housing having a cavity extending in a front-rear direction; a terminal fitting that is housed in the cavity and connects to a front end portion of an electric wire; and a rubber plug that fits onto the electric wire and is coupled to the terminal fitting, wherein the rubber plug includes: a body portion that has a seal lip that comes into close contact with an inner circumferential surface of the cavity; an extended portion that extends rearward from the body portion and is disposed outside the housing; and a bulging portion that bulges outward in a radial direction of the extended portion, and comes into contact with a rear surface of the housing in a state where the electric wire disposed inside the extended portion is bent in a direction that intersects the front-rear direction.

In the connector in (1), supposing that the electric wire located outside the housing is subjected to an external force and is bent relative to the front-rear direction, the bulging portion will come into contact with the rear surface of the housing and keep the electric wire from bending any further. As a result, the external force acting on the electric wire is unlikely to be transmitted to the terminal fitting housed in the cavity, tilting of the terminal fitting is suppressed, and the terminal fitting can be appropriately connected to a partner terminal fitting in an orientation extending along the front-rear direction.

(2) The connector according to (1), wherein the bulging portion includes a plurality of flange portions that are arranged in the front-rear direction and protrude from an outer circumferential surface of the extended portion, and the plurality of flange portions come into contact with each other in the state where the electric wire is bent in a direction that intersects the front-rear direction.

In the connector in (2), the flange portions move closer to each other and come into contact with the housing, and thus a thickness and rigidity with which the bulging portion can suppress bending of the electric wire can be ensured.

(3) The connector according to (1) or (2), wherein the body portion has an elastic portion located rearward of the seal lip and contactable with an inner circumferential surface of the cavity around a circumferential direction, and the extended portion is thinner walled than the elastic portion in the radial direction.

In the connector in (3), by disposing the elastic portion so as to be able to come into contact with the inner circumferential surface of the cavity along the circumferential direction, bending of the electric wire disposed inside the elastic portion is suppressed, and furthermore, tilting of the terminal fitting housed in the cavity is suppressed with high probability.

(4) The connector according to (3), wherein a front end portion of the extended portion is continuous with a rear end portion of the elastic portion on the inner side in the radial direction, and the extended portion extends rearward from the inner side in the radial direction of a rear surface of the elastic portion.

In the connector in (4), when the extended portion bends in response to bending of the electric wire, the elastic portion side is unlikely to be influenced by bending of the extended portion and thus unlikely to deform, which makes it is easy to maintain a state where the elastic portion is in contact with the inner circumferential surface of the cavity along the circumferential direction.

(5) The connector according to (1) or (2), wherein an outer diameter of the bulging portion is greater than an opening diameter of the cavity in the housing.

In the connector in (5), even if water is dispersed toward the rear surface of the housing in a state where the electric wire is disposed along the front-rear direction, the bulging portion can block the water and thus make it less likely for water to enter between the inner circumferential surface of the cavity and the outer circumferential surface of the body portion.

### Details of Embodiments of the Present Disclosure

### Embodiment 1

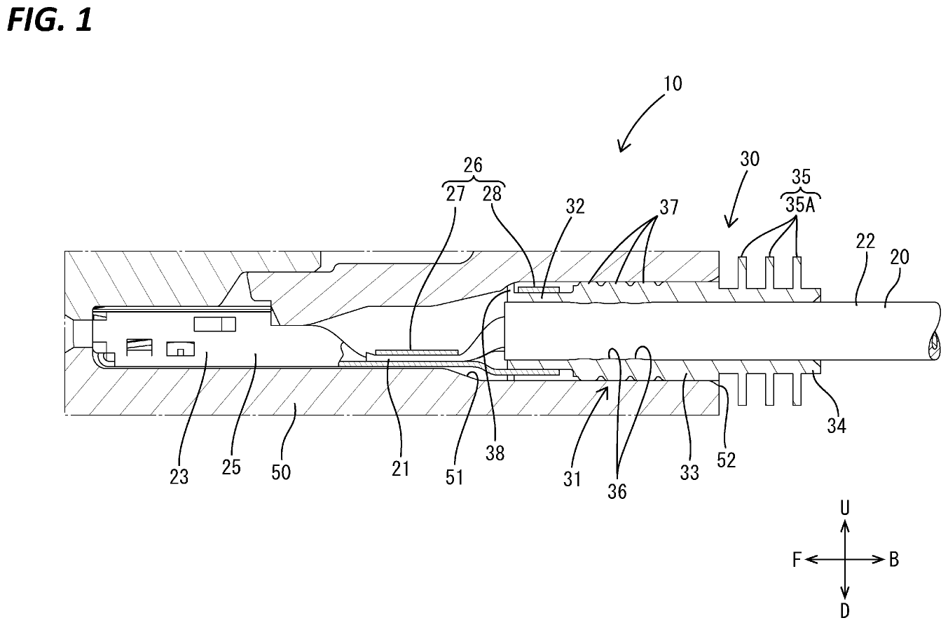

Embodiment 1 of a connector 10 according to the present disclosure will be described with reference to FIGS. 1 to 4. In the drawings, the front side is indicated by F, the rear side is indicated with B, the upper side is indicated with U, the lower side is indicated with D, the right side is indicated with R, and the left side is indicated with L. As shown in FIG. 1, the connector 10 includes a housing 50, a terminal fitting 25, and a rubber plug 30.

The housing 50 is made of a synthetic resin, for example. The housing 50 is provided with a cavity 51 extending in the front-rear direction.

The terminal fitting 25 has an overall elongated shape in the front-rear direction. The front end portion of the terminal fitting 25 is provided with a box portion 23 that has a square tubular shape extending in the front-rear direction. The rear end portion of the terminal fitting 25 is provided with a fastening portion 26 that has an open-barrel shape so as to be crimpable to the front end portion of an electric wire 20. The fastening portion 26 is constituted by a wire barrel portion 27 and an insulation barrel portion 28 that is continuous with the rear end of the wire barrel portion 27. The wire barrel portion 27 is connected to a conductor 21 exposed by removing an insulative coating 22 from the front end portion of the electric wire 20. The insulation barrel portion 28 is fixed to a later-described crimping portion 32 at a front end portion of the rubber plug 30 fitted to the electric wire 20.

The rubber plug 30 is made of a rubber such as silicone rubber or NBR (acrylonitrile-butadiene rubber). The rubber plug 30 is fitted to the electric wire 20 so as to surround the front end portion of the electric wire 20 where the conductor 21 is surrounded by the insulative coating 22. The rubber plug 30 is coupled to the terminal fitting 25 as well as the electric wire 20, and is housed in a cavity 51 of the housing 50 along with the electric wire 20. The rubber plug 30 exhibits a water-proofing function of sealing the space between the outer circumferential surface of the electric wire 20 and the inner circumferential surface of the cavity 51 in a liquid-tight manner.

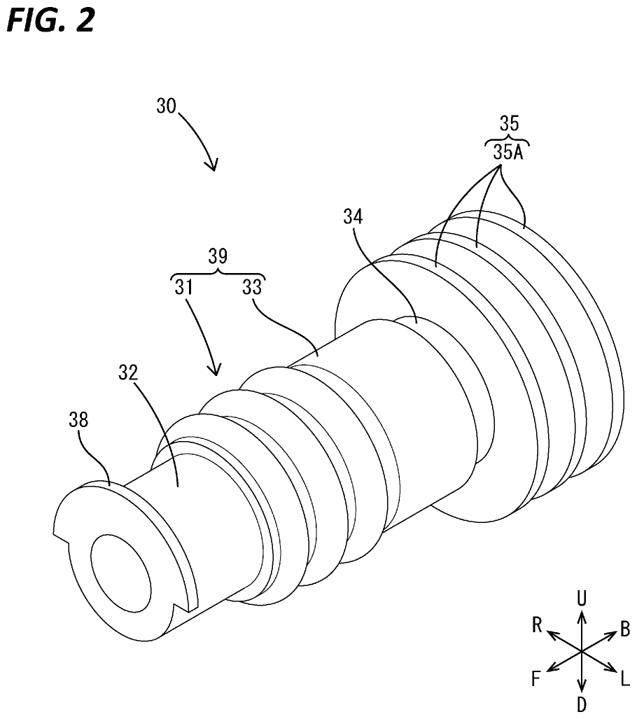

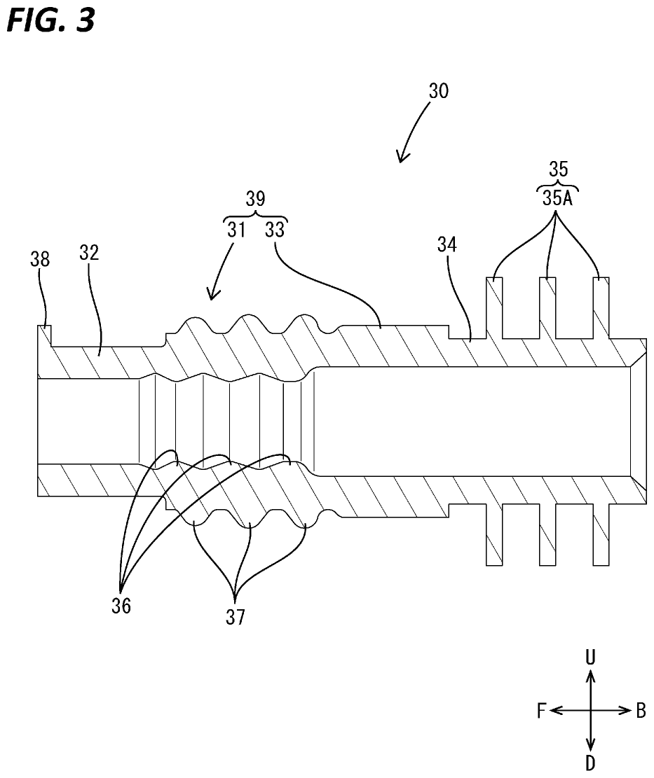

The rubber plug 30 is a single component with an overall cylindrical shape. As shown in FIGS. 2 and 3, the rubber plug 30 has a body portion 39, the crimping portion 32, an extended portion 34, and a bulging portion 35. The body portion 39 has a seal lip 31 and an elastic portion 33. The bulging portion 35 has a plurality of flange portions 35A. The inner circumferential surface of the seal lip 31 is provided with inner circumferential lip portions 36 that extend in the circumferential direction and are arranged at constant intervals in the front-rear direction (see FIG. 3). The outer circumferential surface of the seal lip 31 is provided with outer circumferential lip portions 37 that extend in the circumferential direction and are arranged at constant intervals in the front-rear direction. The inner circumferential lip portions 36 come into close contact with the outer circumferential surface of the insulative coating 22 of the electric wire 20 in a liquid-tight manner. The outer circumference of the outer circumferential lip portions 37 is larger than the inner diameter of the cavity 51. The outer circumferential lip portions 37 come into close contact with the inner circumferential surface of the cavity 51 in a liquid-tight manner (see FIG. 1).

The elastic portion 33 is disposed rearward of the seal lip 31. Specifically, the elastic portion 33 has a form of extending coaxially rearward from the rear end of the seal lip 31. The length of the elastic portion 33 in the front-rear direction is smaller than the length of the seal lip 31 in the front-rear direction (see FIG. 3). The inner and outer diameters of the elastic portion 33 are both constant over the entire length of the elastic portion 33 in the front-rear direction. The inner diameter of the elastic portion 33 is greater than the smallest inner diameter of the seal lip 31 (the smallest diameter of the inner circumferential lip portions 36) (see FIG. 3). The inner diameter of the elastic portion 33 is smaller than or equal to the outer diameter of the electric wire 20, that is, equal to the outer diameter of the electric wire 20 or slightly smaller than the outer diameter of the electric wire 20. The outer diameter of the elastic portion 33 is smaller than the largest outer diameter of the seal lip 31 (the largest outer diameter of the outer circumferential lip portions 37) (see FIG. 3). The outer diameter of the elastic portion 33 is smaller than or equal to the inner diameter of the cavity 51, that is, equal to the inner diameter of the cavity 51 or slightly smaller than the inner diameter of the cavity 51.

The crimping portion 32 has a form of extending coaxially forward from the front end of the seal lip 31. In a state where the electric wire 20 does not extend through the rubber plug 30, the inner and outer diameters of the crimping portion 32 are both constant along the entire length of the crimping portion 32 in the front-rear direction. The inner diameter of the crimping portion 32 is larger than the smallest inner diameter of the seal lip 31 (smallest diameter of the inner circumferential lip portions 36) (see FIG. 3). The outer diameter of the crimping portion 32 is smaller than the largest outer diameter of the seal lip 31 (largest outer diameter of the outer circumferential lip portions 37) (see FIG. 3).

The front end portion of the crimping portion 32 is provided with a single side protrusion 38 that extends in a semi-circle shape from the outer circumferential surface on the upper half of the crimping portion 32 and expands outward in the radial direction of the rubber plug 30 (hereinafter, simply referred to as the “radial direction”). The outer diameter of the single side protrusion 38 is smaller than the outer diameter of the outer circumferential lip portions 37 (see FIG. 3). The outer diameter of the single side protrusion 38 is slightly smaller than the inner diameter of the cavity 51. In a state where the crimping portion 32 is fixed to the insulation barrel portion 28, the single side protrusion 38 is located forward of the insulation barrel portion 28 (see FIG. 1). The single side protrusion 38 has a function of preventing the crimping portion 32 of the rubber plug 30 from dislodging from the insulation barrel portion 28. As a result of the single side protrusion 38 elastically coming into surface contact with the inner circumferential surface of the cavity 51, the single side protrusion 38 has a function of preventing the rubber plug 30 from collapsing.

The extended portion 34 has a form of extending coaxially rearward from the rear end of the elastic portion 33. The front end portion of the extended portion 34 is continuous with the rear end portion of the elastic portion 33 with the diameter of the front end portion being reduced inward in the radial direction. The front end portion of the extended portion 34 and the rear end portion of the elastic portion 33 are connected in the manner of a step. The inner diameter of the extended portion 34 in a state where the electric wire 20 is not passed through the rubber plug 30 is a constant dimension along the entire length of the extended portion 34 in the front-rear direction, and is equal to the inner diameter of the elastic portion 33 (see FIG. 3). Accordingly, the inner circumferential surface of the elastic portion 33 and the inner circumferential surface of the extended portion 34 are flush with each other without a level change. The outer diameter of the extended portion 34 is smaller than the outer diameter of the elastic portion 33. The wall thickness of the extended portion 34 in the radial direction is smaller than the wall thickness of the elastic portion 33 (see FIG. 3). Accordingly, the rigidity of the extended portion 34 when an external force acts so as to curve the axis of the rubber plug 30 is less than the rigidity of the elastic portion 33. Thus, when an external force acts so as to curve the axis of the rubber plug 30, the extended portion 34 is more likely to deform than the elastic portion 33. In other words, the extended portion 34 operates so as to elastically deform under an external force acting to curve the axis of the rubber plug 30 in order to keep the external force from being transmitted to the elastic portion 33.

The flange portions 35A of the bulging portion 35 are arranged in the front-rear direction on the outer circumferential surface of the extended portion 34 and jut out outward in a flange shape in the radial direction. The flange portions 35A are coaxial with the extended portion 34. The flange portions 35A are separated from each other by a predetermined distance in the front-rear direction. The foremost flange portion 35A is located rearward of the rear end of the elastic portion 33 at a distance from the rear end of the elastic portion 33. The rearmost flange portion 35A is located forward of the rear end of the extended portion 34. The outer diameter of each flange portion 35A is greater than the largest outer diameter of the seal lip 31. The distance between adjacent flange portions 35A in the front-rear direction is greater than the thickness of each flange portion 35A in the front-rear direction.

As shown in FIG. 1, in a state where the terminal fitting 25 and the rubber plug 30 coupled to the electric wire 20 are inserted into the cavity 51, the entire crimping portion 32, the entire seal lip 31, and the entire elastic portion 33 are housed in the cavity 51. The extended portion 34 is disposed rearward (that is, outside) of the housing 50. For example, the inner surface of the front end portion of the cavity 51 is provided with a projection protruding inward (not shown). Contact between the projection and the outer surface of the front end portion of the terminal fitting 25 (box portion 23) restricts shifting (i.e., rattling) of the front end portion of the terminal fitting 25 in the up-down direction and the left-right direction.

The seal lip 31 elastically deforms in the manner of being crushed so as to become thinner in the radial direction, and thus the inner circumferential lip portions 36 elastically come into close contact with the outer circumferential surface of the electric wire 20 and the outer circumferential lip portions 37 elastically come into close contact with the inner circumferential surface of the cavity 51. With this form of close contact, a gap between the outer circumference of the electric wire 20 and the inner circumference of the cavity 51 is sealed off in a liquid-tight manner.

In a state where the terminal fitting 25 and the rubber plug 30 coupled to the electric wire 20 are inserted into the cavity 51, the outer circumferential surface of the single side protrusion 38 provided at the leading end portion of the crimping portion 32 elastically comes into surface contact with the inner circumferential surface of the cavity 51. The outer circumferential surface of the elastic portion 33 elastically comes into surface contact with the inner circumferential surface of the cavity 51 along a circumferential direction. As a result of the single side protrusion 38 and the elastic portion 33 elastically coming into surface contact with the inner circumferential surface of the cavity 51, the rear end portion of the terminal fitting 25 is restricted from shifting in the up-down direction and the left-right direction.

The entirety of the extended portion 34 and all of the flange portions 35A (bulging portion 35) protrude outside the cavity 51, that is, protrude on the outer rear side of the housing 50. The outer diameter of the flange portions 35A (bulging portion 35) is larger than the opening diameter of the cavity 51 in a rear surface 52 of the housing 50. The region of the electric wire 20 located rearward of the rubber plug 30 is also drawn out rearward from the housing 50.

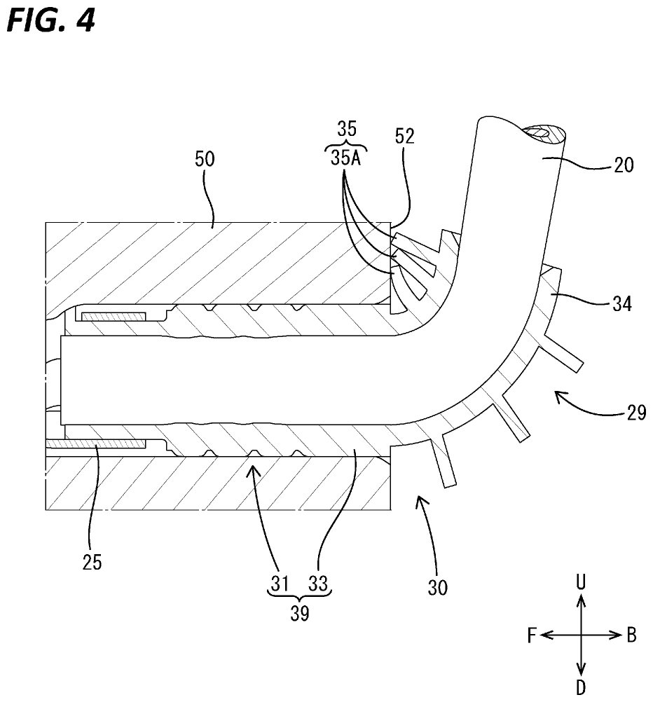

As shown in FIG. 4, when a drawn-out portion 29 of the electric wire 20 that extends outside the housing 50 is routed in a bent state so as to curve in a direction that intersects the front-rear direction, the extended portion 34 elastically deforms to follow the bend in the drawn-out portion 29. In FIG. 4, the drawn-out portion 29 is curved in an upward direction that intersects the front-rear direction. Accordingly, the leading end portions on the outer circumferential edges of the flange portions 35A on the elastically deformed side of the extended portion 34 move closer to and come into contact with each other as well as come into contact with the rear surface 52 of the housing 50. In other words, the bulging portion 35 (the flange portions 35A) comes into contact with the rear surface 52 of the housing 50 in a state where the electric wire 20 disposed inside the extended portion 34 extends bent in a direction that intersects the front-rear direction. Note that a case may also occur where the leading end portions on the outer circumferential edges of the flange portions 35A move closer to and come into contact with each other but only the foremost flange portion 35A comes into contact with the rear surface 52 of the housing 50.

In doing so, as a result of the outer circumferential edges of the flange portions 35A coming into contact with the rear surface 52 of the housing 50, friction (e.g., static friction) is generated between the outer circumferential edges of the flange portions 35A and the rear surface 52 of the housing 50, and a function of preventing the rubber plug 30 in the cavity 51 from elastically deforming in a curving direction of the drawn-out portion 29 is exhibited. Thus, the water-proofing function of the rubber plug 30 is maintained. Also, the elastic deformation of the body portion 39 of the rubber plug 30 is suppressed, and thus the electric wire 20 in the rubber plug 30 and the rear end portion of the terminal fitting 25 coupled to the electric wire 20 are restricted from shifting in the up-down direction and the left-right direction, and accordingly, tilting of the terminal fitting 25 relative to the cavity 51 can be suppressed.

Also, as a result of the outer circumferential edge portions of the flange portions 35A coming into contact with each other, it is possible to prevent the electric wire 20 from bending sharply at the rear end of the elastic portion 33 that is continuous with the front end of the extended portion 34, and to cause the electric wire 20 to be bent so as to curve at a predetermined radius of curvature. Accordingly, it is possible to prevent the insulative coating 22 from tearing and the electric wire 20 from breaking at the rear end of the elastic portion 33 that is continuous with the front end of the extended portion 34.

Next, operation of Embodiment 1 will be described.

The connector 10 includes the housing 50 having the cavity 51 extending in the front-rear direction, the terminal fitting 25 housed in the cavity 51 and connected to the front end portion of the electric wire 20, and the rubber plug 30 fitted to the electric wire 20 and coupled to the terminal fitting 25. The rubber plug 30 has the body portion 39, the extended portion 34, and the bulging portion 35. The body portion 39 has the seal lip 31 that comes into close contact with the inner circumferential surface of the cavity 51. The extended portion 34 extends rearward from the body portion 39 and is disposed outside the housing 50. The bulging portion 35 bulges outward in a radial direction of the extended portion 34, and comes into contact with the rear surface 52 of the housing 50 in a state where the electric wire 20 disposed inside the extended portion 34 is bent in a direction that intersects the front-rear direction.

With this configuration, supposing that the electric wire 20 located outside the housing 50 is subjected to an external force and is bent relative to the front-rear direction, the bulging portion 35 will come into contact with the rear surface 52 of the housing 50 and keep the electric wire 20 from bending any further. As a result, tilting of the terminal fitting 25 housed in the cavity 51 is also suppressed, and the terminal fitting 25 can be appropriately connected to a partner terminal fitting in an orientation extending along the front-rear direction.

The bulging portion 35 has a plurality flange portions 35A that are arranged in the front-rear direction and protrude from the outer circumferential surface of the extended portion 34, and the leading ends on the outer circumferences of the flange portions 35A move closer and come into contact with each other when the electric wire 20 is bent in a direction that intersects the front-rear direction. With this configuration, the leading ends on the outer circumferences of the flange portions 35A move closer and come into contact with each other, and thus a thickness and rigidity with which the bulging portion 35 can suppress bending of the electric wire 20 can be ensured.

The body portion 39 has the elastic portion 33 that is located rearward of the seal lip 31 and is capable of coming into contact with the inner circumferential surface of the cavity 51 along the circumferential direction, and the extended portion 34 is thinner walled than the elastic portion 33 in the radial direction. With this configuration, by disposing the elastic portion 33 so as to be able to come into contact with the inner circumferential surface of the cavity 51 along the circumferential direction, bending of the electric wire 20 disposed inside the elastic portion 33 is suppressed, and furthermore, tilting of the terminal fitting 25 housed in the cavity 51 is suppressed with high probability.

The front end portion of the extended portion 34 is continuous with the rear end portion of the elastic portion 33 on the inner side in the radial direction, and the extended portion 34 extends rearward from the inner side in the radial direction of the rear surface of the elastic portion 33. With this configuration, when the extended portion 34 bends in response to bending of the electric wire 20, the elastic portion 33 side is unlikely to be influenced by bending of the extended portion 34 and thus unlikely to deform, which makes it is easy to maintain a state where the elastic portion 33 is in contact with the inner circumferential surface of the cavity 51 along the circumferential direction.

The outer diameter of the bulging portion 35 is greater than the opening diameter of the cavity 51 in the housing 50. With this configuration, when water is dispersed toward the rear surface 52 of the housing 50 in a state where the electric wire 20 is disposed along the front-rear direction, the bulging portion 35 can block the water, and thus make it less likely for water to enter between the inner circumferential surface of the cavity 51 and the outer circumferential surface of the body portion 39.

### Other Embodiments

The embodiments disclosed herein are exemplary in all respects, and should be construed as not being restrictive. The scope of the present invention is indicated by the claims rather than being limited to the thus disclosed embodiments, and all changes that come within the meaning and range of equivalency of the claims are intended to be embraced therein.

Unlike Embodiment 1, the flange portions may have different outer diameters. Also, the thicknesses of the flanges in the axial direction may differ.

The number of flange portions is not limited to that in Embodiment 1.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector comprising:
a housing having a cavity extending in a front-rear direction;
a terminal fitting that is housed in the cavity and connects to a front end portion of an electric wire; and
a rubber plug that fits onto the electric wire and is coupled to the terminal fitting,
wherein the rubber plug includes:
a body portion that has a seal lip that comes into close contact with an inner circumferential surface of the cavity;
an extended portion that extends rearward from the body portion and is disposed outside the housing; and
a bulging portion that bulges outward in a radial direction of the extended portion, and comes into contact with a rear surface of the housing in a state where the electric wire disposed inside the extended portion is bent in a direction that intersects the front-rear direction.

2. The connector according to claim 1,
wherein the bulging portion includes a plurality of flange portions that are arranged in the front-rear direction and protrude from an outer circumferential surface of the extended portion, and
the plurality of flange portions come into contact with each other in the state where the electric wire is bent in a direction that intersects the front-rear direction.

3. The connector according to claim 1,
wherein the body portion has an elastic portion located rearward of the seal lip and contactable with an inner circumferential surface of the cavity around a circumferential direction, and
the extended portion is thinner walled than the elastic portion in the radial direction.

4. The connector according to claim 3,
wherein a front end portion of the extended portion is continuous with a rear end portion of the elastic portion on the inner side in the radial direction, and
the extended portion extends rearward from the inner side in the radial direction of a rear surface of the elastic portion.

5. The connector according to claim 1,
wherein an outer diameter of the bulging portion is greater than an opening diameter of the cavity in the housing.
